(19) United States
(12) Patent Application Publication
(10) Pub. No.: US 2016/0039074 A1
(43) Pub. Date: Feb. 11, 2016

(54) Moving Structure of a Movable Jaw for an Adjustable Wrench

(71) Applicant: Yang Hua Lee, Changhua City (TW)

(72) Inventor: Yang Hua Lee, Changhua City (TW)

(21) Appl. No.: 14/452,747

(22) Filed: Aug. 6, 2014

(51) Int. Cl. B25B 13/22; B25B 23/00

(52) U.S. Cl. CPC B25B 13/22; B25B 23/0007

(57) ABSTRACT

A moving structure of a movable jaw for an adjustable wrench; wherein an adjustable wrench contains an operating handle, a movable jaw, an abutting assembly, and an adjusting assembly. The operating handle includes a driving head with a fixed jaw, a slot, and a cavity. The movable jaw includes a sliding extension with a plurality of locking teeth and includes a clamping portion. The abutting assembly includes a pushing element accommodated in the cavity and a first resilient element, and the pushing member matches with the first resilient element to engage with the plurality of locking teeth of the movable jaw. The adjusting assembly includes a rotary lever and a torsion spring, and the rotary lever has an acting portion and a rotating portion, such that the rotary lever is pressed and released repeatedly to drive the movable jaw to move toward the fixed jaw.

### BACKGROUND OF THE INVENTION

1. Field of the Invention

The present invention relates to an adjustable wrench, and more particularly to a moving structure of a movable jaw for the adjustable wrench.

2. Description of the Prior Art

A conventionally hand tool, such as an adjustable wrench is applied for maintenance in a factory, assembly of vehicle, and DIY in daily life. The adjustable wrench contains a fixed jaw and a movable jaw for clamping workpieces (such as screws or nuts, etc.), and a distance between the fixed jaw and the movable jaw is adjusted depending on various sizes of workpieces, such that the adjustable wrench is rotated clockwise or counterclockwise to lock or unlock the workpiece. Accordingly, the adjustable wrench can be used to unlock and unlock the various sizes of workpieces.

The adjustable wrench contains an operating handle, a worm, and a movable jaw. The operating handle includes a fixed jaw disposed on one end thereof, a slot defined proximate to the fixed jaw, and a cavity communicating with the slot. The worm has toothed threads arranged around an outer surface thereof and is accommodated in the cavity, such that the worm rotates in the cavity relative to the operating handle. The movable jaw has a first end received in the slot of the operating handle, a second end corresponding to the fixed jaw, and plural toothed racks arranged on the first end thereof, such that when the worm is received in the cavity, the toothed threads engage with the plural toothed racks of the movable jaw, hence when the worm rotates in the cavity, the toothed threads push the plural racks to move toward or away from the fixed jaw, thus adjusting the distance between the movable jaw and the fixed jaw.

However, the adjustable wrench has some defects, for example, when the worm drives the movable jaw to move, a contacting area between the toothed threads of the worm and the plural toothed racks of the movable jaw is small, and a rotating path of the toothed threads is long, so the movable jaw is moved in the slot slowly, thus adjusting the distance between the movable jaw and the fixed jaw inefficiently. Furthermore, the worm is pushed to rotate by user's finger and the toothed threads of the worm, thereby injuring the user's finger carelessly.

The present invention has arisen to mitigate and/or obviate the afore-described disadvantages.

### SUMMARY OF THE INVENTION

The primary objective of the present invention is to provide a moving structure of a movable jaw for an adjustable wrench in which a rotary lever is pressed and released to move the movable jaw toward a fixed jaw quickly, thus locking or unlocking a workpiece efficiently.

Another objective of the present invention is to provide a moving structure of a movable jaw for an adjustable wrench in which the rotary lever coupled with a driving head of an operating handle is pressed to drive an actuating member by which the movable jaw is moved toward the fixed jaw, thus operating the moving structure of the movable jaw easily and safely.

To obtain the above objectives, a moving structure of a movable jaw for an adjustable wrench provided by the present invention, wherein the adjustable wrench contains: an operating handle, a movable jaw, an abutting assembly, and an adjusting assembly.

The operating handle includes a driving head arranged on one end thereof. The driving head has a fixed jaw, a slot extending through the fixed jaw, and a cavity communicating with the slot.

The movable jaw includes a sliding extension formed on a first end thereof and mounted in the slot of the driving head of the operating handle, and the sliding extension has a plurality of locking teeth, the movable jaw also includes a clamping portion fixed on a second end thereof to correspond to the fixed jaw.

The abutting assembly includes a pushing element and a first resilient element, and the pushing member is accommodated in the cavity of the operating handle and matches with the first resilient element to engage with the plurality of locking teeth of the movable jaw, thus positioning the movable jaw.

The adjusting assembly includes a rotary lever and a torsion spring, the rotary lever and the torsion spring are coupled with the driving head of the operating handle, and the rotary lever has an acting portion formed on a first end thereof and received in the cavity of the driving head of the operating handle, the rotary lever also has a rotating portion arranged on a second end thereof and extending out of the cavity of the driving head of the operating handle, such that the rotary lever is pressed and released repeatedly to drive the movable jaw to move toward the fixed jaw.

### BRIEF DESCRIPTION OF THE DRAWINGS

FIG. 1 is a perspective view showing the exploded components of a moving structure of a movable jaw for an adjustable wrench according to a first embodiment of the present invention.

FIG. 2 is a perspective view showing the assembly of the moving structure of the movable jaw for the adjustable wrench according to the first embodiment of the present invention.

FIG. 3 is a cross sectional view showing the assembly of a part of the moving structure of the movable jaw for the adjustable wrench according to the first embodiment of the present invention.

FIG. 4 is a cross sectional view showing the operation of a part of the moving structure of the movable jaw for the adjustable wrench according to the first embodiment of the present invention.

FIG. 5 is another cross sectional view showing the operation of a part of the moving structure of the movable jaw for the adjustable wrench according to the first embodiment of the present invention.

FIG. 6 is a cross sectional view showing the operation of a rotary lever of the moving structure of the movable jaw for the adjustable wrench according to the first embodiment of the present invention.

FIG. 7 is also another cross sectional view showing the operation of a part of the moving structure of the movable jaw for the adjustable wrench according to the first embodiment of the present invention.

FIG. 8 is still another cross sectional view showing the operation of a part of the moving structure of the movable jaw for the adjustable wrench according to the first embodiment of the present invention.

FIG. 9 is a partial perspective view showing the assembly of an adjusting assembly of a moving structure of a movable jaw for an adjustable wrench according to a second embodiment of the present invention.

FIG. 10 is a partial cross sectional view showing the assembly of the adjusting assembly of the moving structure of the movable jaw for the adjustable wrench according to the second embodiment of the present invention.

### DETAILED DESCRIPTION OF THE PREFERRED EMBODIMENTS

The present invention will be clearer from the following description when viewed together with the accompanying drawings, which show, for purpose of illustration only, the preferred embodiments in accordance with the present invention.

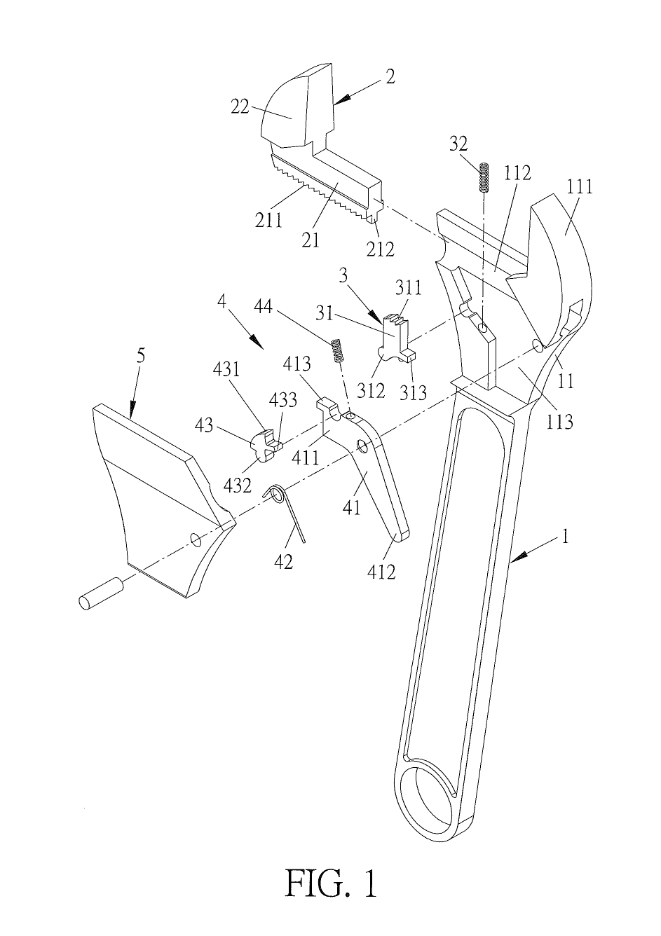

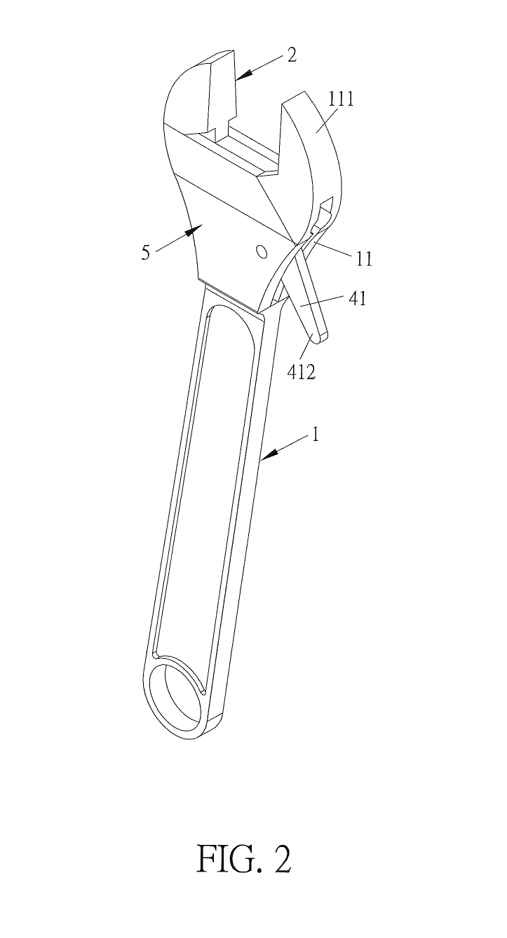

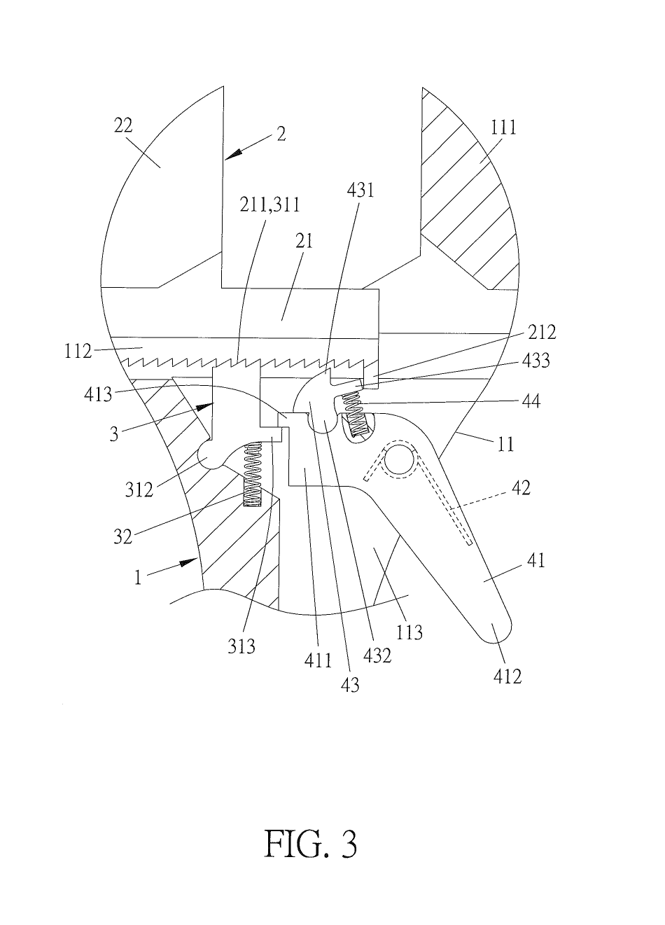

With reference to FIGS. 1-3, a moving structure of a movable jaw for an adjustable wrench according to a first embodiment of the present invention comprises: an operating handle 1, a movable jaw 2, an abutting assembly 3, an adjusting assembly 4, and a cover 5. The operating handle 1 includes a driving head 11 arranged on one end thereof, the driving head 11 has a fixed jaw 111 disposed on an edge thereof away from the operating handle 1, a slot 112 extending through the fixed jaw 111, and a cavity 113 formed on one side surface thereof and communicating with the slot 112. The movable jaw 2 includes a sliding extension 21 formed on a first end thereof and mounted in the slot 112 of the driving head 11 of the operating handle 1, and the sliding extension 21 has a plurality of locking teeth 211 arranged in one side thereof opposite to the slot 112 of the driving head 11, wherein the plurality of locking teeth 211 are arranged in a single row. The movable jaw 2 also includes a clamping portion 22 fixed on a second end thereof to correspond to the fixed jaw 111. The abutting assembly 3 includes a pushing element 31 and a first resilient element 32, and the pushing member 31 has plural engaging teeth 311 formed on a first end thereof and a connecting portion 312 and a resisting portion 313 which are arranged on a second end of the pushing member 31, the pushing member 31 is accommodated in the cavity 113 of the operating handle 1 and connects with a peripheral wall of the cavity 113 of the operating handle 1 by ways of the connecting portion 312. The first resilient element 32 is defined between the pushing member 31 and the peripheral wall of the cavity 113 of the driving head 11 of the operating handle 1, such that the pushing member 31 is pushed toward the movable jaw 2, and the plural engaging teeth 311 of the pushing member 31 engage with the plurality of locking teeth 211 of the movable jaw 2, hence the movable jaw 2 is abutted by the pushing member 31. The adjusting assembly 4 includes a rotary lever 41, a torsion spring 42, an actuating member 43, and a second resilient element 44. The rotary lever 41 and the torsion spring 42 are coupled with the driving head 11 of the operating handle 1, and the rotary lever 41 has an acting portion 411 formed on a first end thereof and received in the cavity 113 of the driving head 11 of the operating handle 1, the rotary lever 41 also has a rotating portion 412 arranged on a second end thereof and extending out of the cavity 113 of the driving head 11 of the operating handle 1. The rotary lever 41 further has a biasing portion 413 extending outwardly from one side of the acting portion 411. The torsion spring 42 is fixed between the rotary lever 41 and the driving head 11 of the operating handle 1 so that the rotary lever 41 moves back to an original position after being pressed. The actuating member 43 has a drive portion 431 extending outwardly from a first end thereof, a joining portion 432 extending outwardly from a second end thereof, and a contacting portion 433 extending outwardly from one side thereof. The actuating member 43 is accommodated in the cavity 113 of the operating handle 1 and is in connection with the acting portion 411 of the rotary lever 41 by using the joining portion 432, and the second resilient element 44 is mounted between the actuating member 43 and the acting portion 411 of the rotary lever 41, such that the actuating member 43 is pushed by the second element 44 to move toward the movable jaw 2. The cover 5 is locked and covered on the cavity 113 of the driving head 11 of the operating handle 1 to limit and protect the sliding extension 21 of the movable jaw 2, the abutting assembly 3, and the adjusting assembly 4.

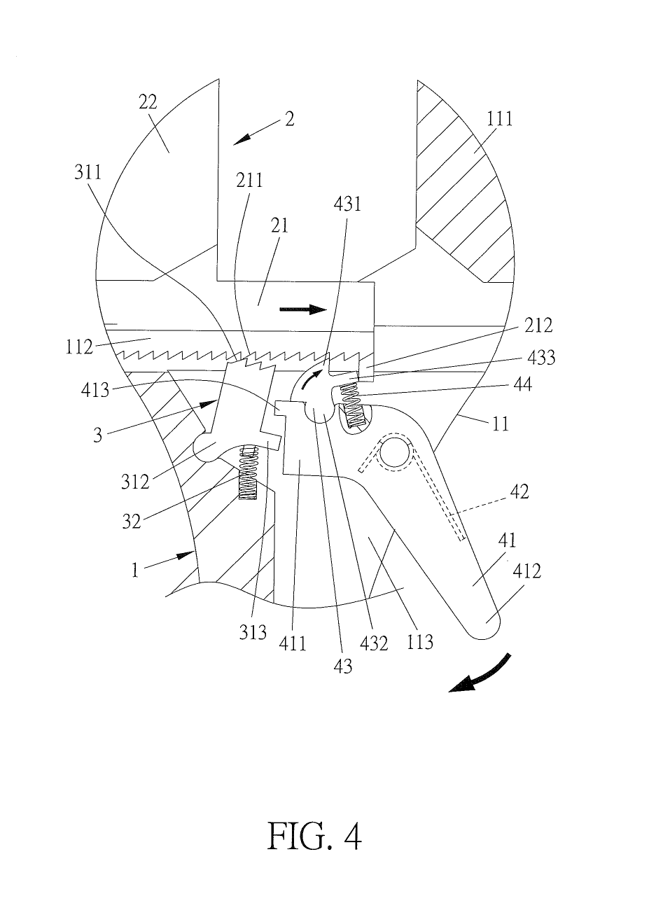

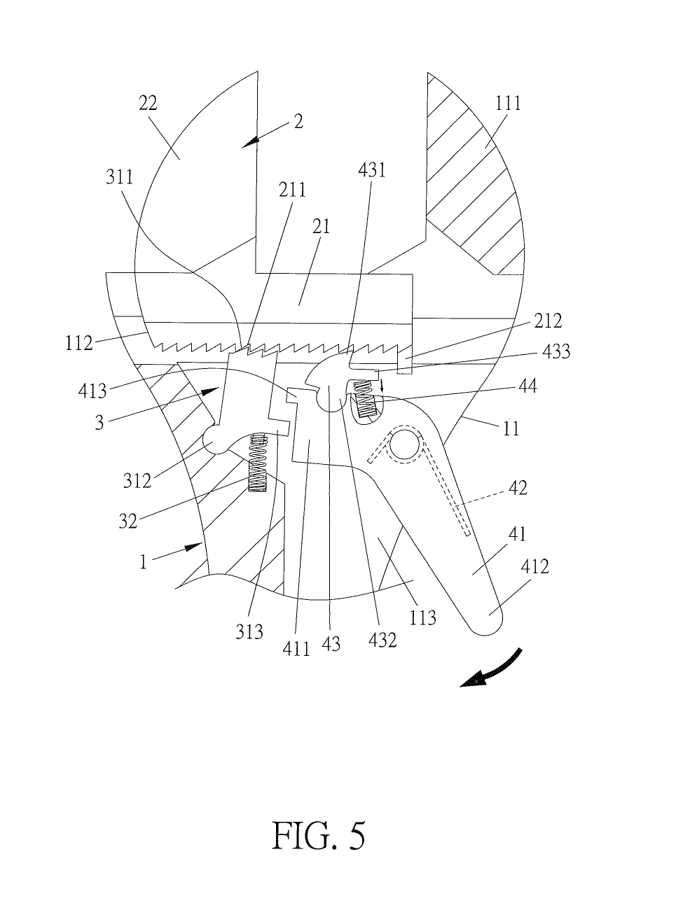

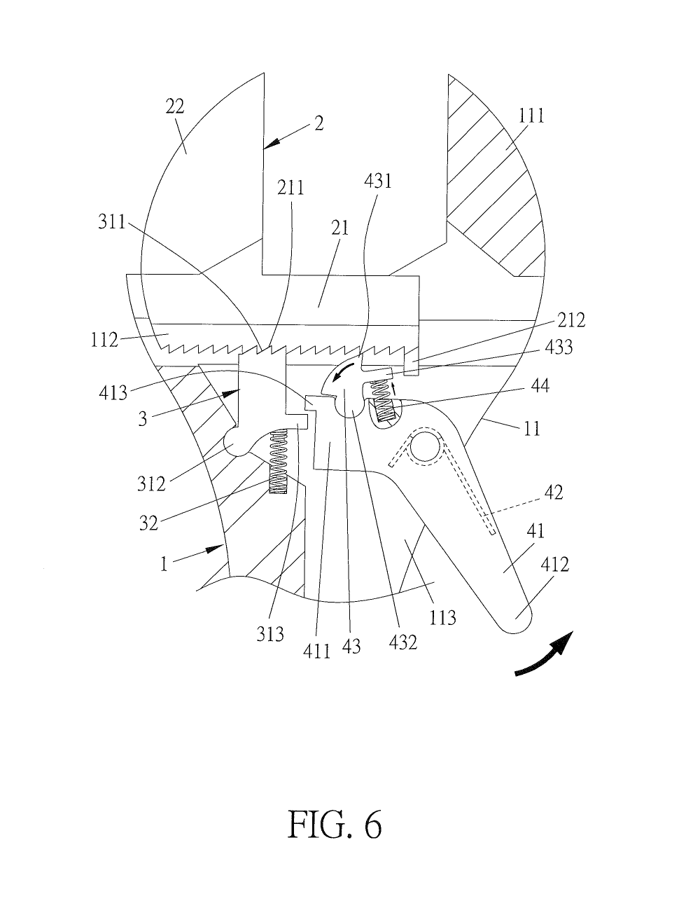

In operation, as shown in FIGS. 4 to 6, the operating handle 1 is gripped by a user, and the rotating portion 412 of the rotary lever 41 of the adjusting assembly 4 is rotated toward the operating handle 1 so that the acting portion 411 of the rotary lever 41 drives the actuating member 43 to move, and the drive portion 431 of the actuating member 43 engages with the plurality of locking teeth 211 of the movable jaw 2, then the movable jaw 2 is driven by the drive portion 431 to move toward the fixed jaw 111, and when releasing the rotating portion 412 of the rotary lever 41, the actuating member 43 is not pushed by the second resilient element 44 to disengage from the plurality of locking teeth 211 of the movable jaw 2 and moves back to an original position, thereafter the rotary lever 41 is pushed by the torsion spring 42 to move back to the original position, thus adjusting a distance between the clamping portion 22 of the movable jaw 2 and the fixed jaw 111 easily. By pressing and releasing the rotary lever 41 repeatedly, the clamping portion 22 of the movable jaw 2 and the fixed jaw 111 clamp a workpiece, and then the operating handle 1 is rotated to rotate the workpiece clockwise and counterclockwise, thus locking or unlocking the workpiece.

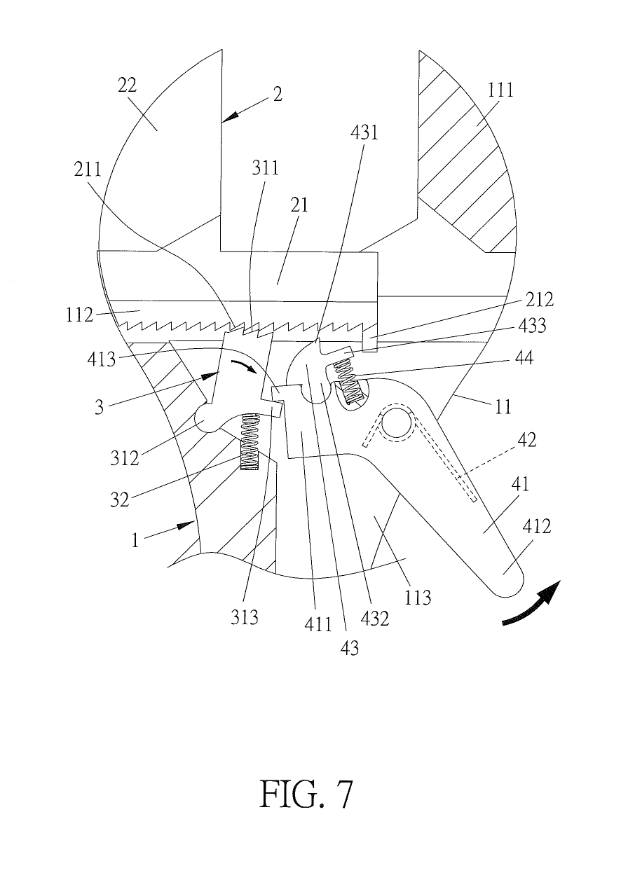

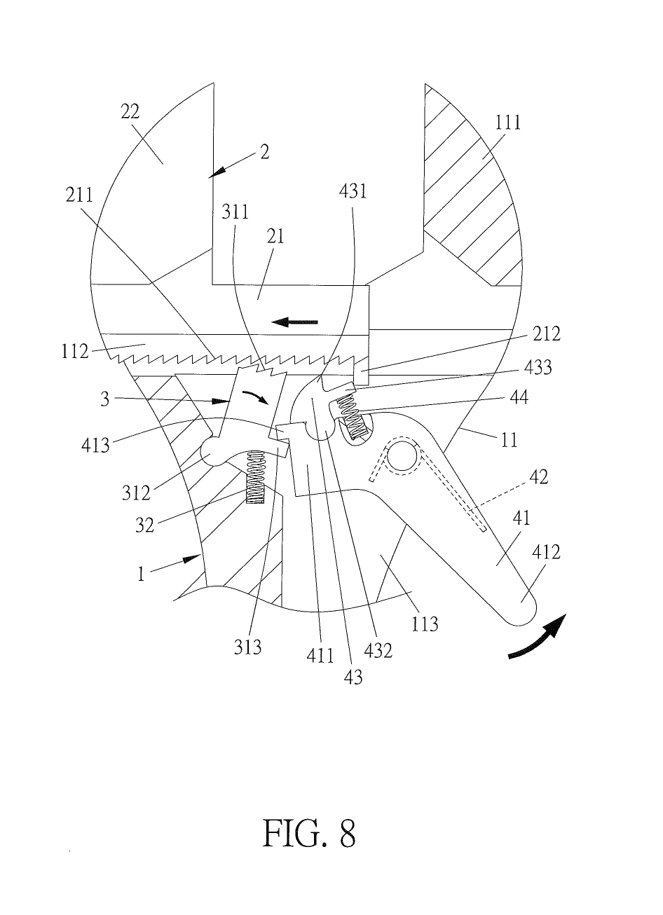

Thereafter, as illustrated in FIGS. 7 and 8, when the rotating portion 412 of the rotary lever 41 of the adjusting assembly 4 is rotated to move away from the operating handle 1, the drive portion 431 of the actuating member 43 moves away from the plurality of locking teeth 211 of the sliding extension 21 of the movable jaw 2, and the biasing portion 413 of the operating lever 41 abuts against the resisting portion 313 of the pushing member 31 of the abutting assembly 3, such that the pushing member 31 is rotated, the first resilient element 32 is pressed, and the plural engaging teeth 311 of the pushing member 31 disengage from the plurality of locking teeth 211 of the movable jaw 2, hence the movable jaw 2 is manually driven to move away from the fixed jaw 111, thus increasing the distance between the clamping portion 22 of the movable jaw 2 and the fixed jaw 111.

Referring further to FIGS. 1 and 8, the sliding extension 21 of the movable jaw 2 has a stopping protrusion 212 arranged on one end thereof away from the clamping portion 22 and facing to the cavity 113 of the driving head 11, such that the stopping shoulder 212 stops the sliding extension 21 of the movable jaw 2 removing from the slot 112 of the driving head 11 of the operating handle 1, when moving the movable jaw 2 away from the fixed jaw 111, thus avoiding a removal of the movable jaw 2.

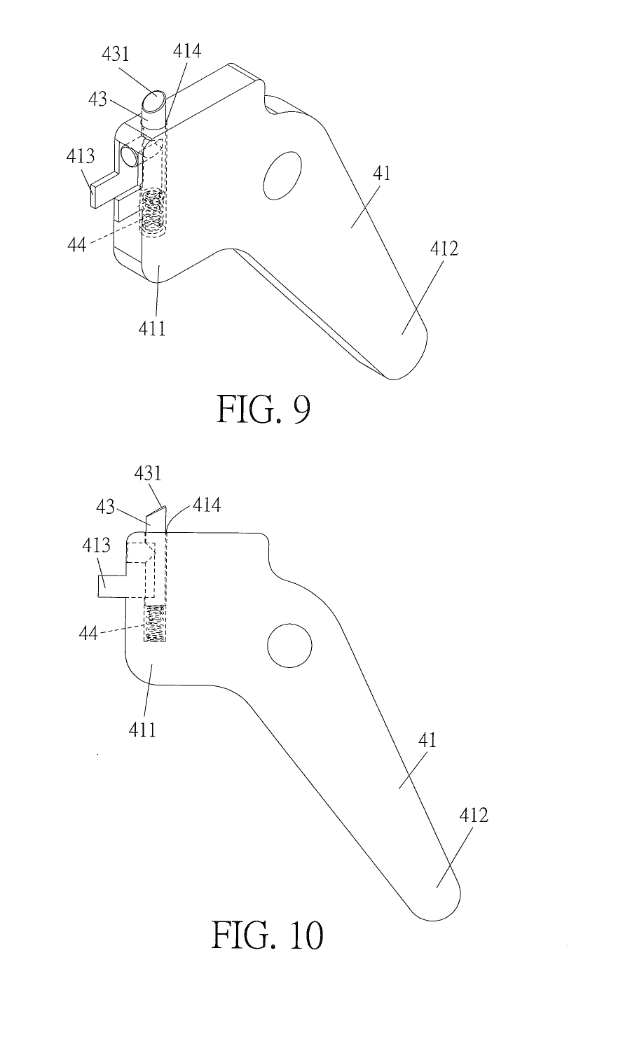

With reference to FIGS. 9 and 10, a moving structure of a movable jaw for an adjustable wrench according to a second embodiment of the present invention comprises: an adjusting assembly 4. The adjusting assembly 4 includes a rotary lever 41, a torsion spring 42, an actuating member 43, and a second resilient element 44. The rotary lever 41 is connected with a cavity 113 of a driving head 11 of an operating handle 1 and has an acting portion 411 arranged on a first end thereof and accommodated in the cavity 113 of the driving head 11 of the operating handle 1. The rotary lever 41 also has a rotating portion 412 of the rotary lever 41 formed on a second end thereof and extending out of the cavity 113 of the driving head 11 of the operating handle 1, a biasing portion 413 extending outwardly from one side of the acting portion 411, and an orifice 414 defined on an end surface of the acting portion 411 facing to the movable jaw 2. The torsion spring 42 is fixed between the rotary lever 41 and the driving head 11 of the operating handle 1 so that the rotary lever 41 moves back to an original position after being pressed. The second resilient element 44 and the actuating member 43 are mounted in the orifice 414 of the rotary lever 41 in turn, and the actuating member 43 is cylindrical and has a drive portion 431 extending toward the orifice 414 from a first end thereof, and a second end of the actuating member 43 is pushed by the second resilient element 44 to move toward the movable jaw 2.

Thereby, the moving structure of a movable jaw of the present invention contains advantages as follows:

1. In use, the rotary lever 41 of the adjusting assembly 4 is pressed, and the torsion spring 42 pushes the rotary lever 41 to move back to an original position, such that the rotary lever 41 is pressed and released repeatedly to move the movable jaw 2 toward the fixed jaw 111, thus locking or unlocking the workpiece.

2. In use, the rotary lever 41 coupled with the driving head 11 of the operating handle 1 is pressed to drive the actuating member 43 by which the movable jaw 2 is moved toward the fixed jaw 111, thus operating the moving structure of the movable jaw easily and safely.

While various embodiments in accordance with the present invention have been shown and described, it is clear to those skilled in the art that further embodiments may be made without departing from the scope of the present invention.

What is claimed is:

1. A moving structure of a movable jaw for an adjustable wrench, wherein an adjustable wrench comprises:
an operating handle including a driving head arranged on one end thereof, the driving head having a fixed jaw, a slot extending through the fixed jaw, and a cavity communicating with the slot;
a movable jaw including a sliding extension formed on a first end thereof and mounted in the slot of the driving head of the operating handle, and the sliding extension having a plurality of locking teeth, the movable jaw also including a clamping portion fixed on a second end thereof to correspond to the fixed jaw;
an abutting assembly including a pushing element and a first resilient element, and the pushing member being accommodated in the cavity of the operating handle and matching with the first resilient element to engage with the plurality of locking teeth of the movable jaw, thus positioning the movable jaw;
an adjusting assembly including a rotary lever and a torsion spring, the rotary lever and the torsion spring being coupled with the driving head of the operating handle, and the rotary lever having an acting portion formed on a first end thereof and received in the cavity of the driving head of the operating handle, the rotary lever also having a rotating portion arranged on a second end thereof and extending out of the cavity of the driving head of the operating handle, such that the rotary lever is pressed and released repeatedly to drive the movable jaw to move toward the fixed jaw.

2. The moving structure of a movable jaw for an adjustable wrench as claimed in claim 1, wherein the adjustable wrench further comprises a cover locked and covered on the cavity of the driving head of the operating handle to limit and protect the sliding extension of the movable jaw, the abutting assembly, and the adjusting assembly.

3. The moving structure of a movable jaw for an adjustable wrench as claimed in claim 1, wherein the cavity of the operating handle is formed on one side surface of the driving head.

4. The moving structure of a movable jaw for an adjustable wrench as claimed in claim 1, wherein the sliding extension of the movable jaw has a stopping protrusion arranged on one end thereof away from the clamping portion and facing to the cavity of the driving head, such that the stopping shoulder stops the movable jaw removing from the slot of the driving head of the operating handle, when moving the movable jaw away from the fixed jaw.

5. The moving structure of a movable jaw for an adjustable wrench as claimed in claim 1, wherein the pushing member of the abutting assembly has plural engaging teeth formed on a first end thereof and a connecting portion and a resisting portion which are arranged on a second end of the pushing member, the pushing member is accommodated in the cavity of the operating handle and connects with a peripheral wall of the cavity of the operating handle by ways of the connecting portion; the first resilient element is defined between the pushing member and the peripheral wall of the cavity of the driving head of the operating handle, such that the pushing member is pushed toward the movable jaw, and the plural engaging teeth of the pushing member engage with the plurality of locking teeth of the movable jaw.

6. The moving structure of a movable jaw for an adjustable wrench as claimed in claim 1, wherein the torsion spring of the adjusting assembly is fixed between the rotary lever and the driving head of the operating handle, such that the rotary lever moves back to an original position after being pressed.

7. The moving structure of a movable jaw for an adjustable wrench as claimed in claim 1, wherein the rotary lever further has a biasing portion extending outwardly from one side of the acting portion.

8. The moving structure of a movable jaw for an adjustable wrench as claimed in claim 1, wherein the adjusting assembly also includes an actuating member and a second resilient element, the actuating member is in connection with the acting portion of the rotary lever by using the second resilient element, and the actuating member is driven by the rotary lever to move the movable jaw toward the fixed jaw.

9. The moving structure of a movable jaw for an adjustable wrench as claimed in claim 8, wherein the actuating member has a drive portion extending outwardly from a first end thereof, a joining portion extending outwardly from a second end thereof, and a contacting portion extending outwardly from one side thereof; the actuating member is accommodated in the cavity of the operating handle and is in connection with the acting portion of the rotary lever by using the joining portion, and the second resilient element is mounted between the actuating member and the acting portion of the rotary lever, such that the actuating member is pushed by the second element to move toward the movable jaw.

10. The moving structure of a movable jaw for an adjustable wrench as claimed in claim 8, wherein the rotary lever also has an orifice defined on an end surface of the acting portion facing to the movable jaw, the second resilient element and the actuating member are mounted in the orifice of the rotary lever, and the actuating member is cylindrical and has a drive portion extending toward the orifice from a first end thereof, and a second end of the actuating member is pushed by the second resilient element to move toward the movable jaw.
